(19) United States
(12) Patent Application Publication
(10) Pub. No.: US 2006/0016483 A1
(43) Pub. Date: Jan. 26, 2006

(54) Valve or valve plate having an integrated gasket

(75) Inventor: David L. Crisp, Commerce Township, MI (US)

Correspondence Address: Robert V. Vickers, Esq.;Fay, Sharpe, Fagan, Minnich & McKee, LLP, Seventh Floor, 1100 Superior Avenue, Cleveland, OH, 44114-2518, US

(73) Assignee: Barnes Group Inc.

(21) Appl. No.: 11/037,660

(22) Filed: Jan. 18, 2005

Related U.S. Application Data
(60) Provisional application No. 60/589,649, filed on Jul. 20, 2004.

(51) Int. Cl. F16K 15/00

(52) U.S. Cl. 137/516.11

(57) ABSTRACT

Valves and valve plates are presented along with fabrication methods therefor, in which a seal is integrated with the valve or valve plate for sealing the valve or valve plate with a mating component without the use of a secondary sealing gasket.

### REFERENCE TO RELATED APPLICATION

This application claims priority to and the benefit of U.S. Provisional Patent Application Ser. No. 60/589,649, which was filed Jul. 20, 2004, entitled VALVE OR VALVE PLATE HAVING AN INTEGRATED GASKET, the entirety of which is hereby incorporated by reference.

### FIELD OF INVENTION

This invention will broadly relate to valves and valve plates and more particularly relate to the use of a coated valve or valve plate to seal against a mating component thus eliminating the need for a secondary gasket in compressors or the like.

### INCORPORATION BY REFERENCE

Vay, U.S. Pat. No. 6,227,825, owned by Barnes Group, Inc., the assignee of the present invention, relates to an improved membrane or flapper valve for transferring fluids or gases in hermetic or semi-hermetic compressors, the entirety of which is hereby incorporated by reference as if-fully set forth herein.

### BACKGROUND OF THE INVENTION

It is well known in the art to use a gasket between a valve and it's mating component or a valve plate and it's mating component. These valves and gaskets are generally used to seal the inside of either a compressor system of an automotive vehicle, refrigerators, etc. Seals are necessary in both the suction and discharge sides of these compressors. Generally, in the prior art a secondary gasket is arranged between either the valve or valve plate and the mating component. During prior art assembly, the secondary gasket has to be correctly aligned and correctly sized to the valve or valve plate being sealed within the compressor environment. The proper gasket material must also be chosen in prior art manufacturing environments to ensure the seal will operate for the required amount of time and be durable during the entire life of the compressor or component being sealed. The assembly of these compressors with the secondary gaskets requires many hours for correct installation of the gaskets into the compressor and complete assembly of the compressor unit.

Many problems have been encountered using secondary gaskets to seal a valve or valve plate in prior art compressors. For example, many of the secondary gaskets are cut or machined to shapes that are not precisely matched to the valve or valve plate seat which is to be sealed in the compressor. Therefore, many of the secondary gaskets are installed even though it is not an exact match to the valve or valve plate seat being sealed, thus leading to the possibility of a leak in the compressor or the like. Furthermore, the employee manufacturing and assembling the compressor may forget to place a seal in one portion of a valve plate or valve, hence leading to durability and leak issues for the compressor because of improper installation. The use of secondary gaskets increases assembly time of the compressor. Also, the use of secondary gaskets may increase the overall assembly length for the final compressor, thus taking up valuable space in either refrigeration or automotive environments.

Therefore, there is a need in the art for an improved method of sealing a valve or valve plate within a compressor of either an automotive or refrigeration environment. There also is a need in the art for a valve or valve plate assembly fabrication method that will facilitate the elimination of any secondary gaskets and/or a reduction in assembly time, along with control over seal compression, texture, and overall space requirements for the compressor in the environment in which they are used. Also, there is a need in the art for a method of making a coated seal that will allow multiple variations in seal pattern and design along with the reduction in assembly time or automated assembly methods for the compressor in a valve or valve plate system. There is also a need in the art for a seal that can be concentrated into a valve or valve plate such that the material rigidity can be adjusted to provide the proper seal to the mating component while the adhesive properties of the material is still exceptional for bonding to the valve or valve plate.

There is also a need in the art for a coated seal that is bonded or otherwise integrated directly onto the valve or valve plate structure, thus removing the entire need for secondary gaskets.

### SUMMARY OF THE INVENTION

The following presents a simplified summary of the invention in order to provide a basic understanding of some aspects of the invention. This summary is not an extensive overview of the invention. It is intended neither to identify key or critical elements of the invention nor to delineate the scope of the invention. Rather, the primary purpose of this summary is to present some concepts of the invention in a simplified form as a prelude to the more detailed description that is presented later.

The invention relates to the integration of seal gaskets into valves or valve plates to create a valve/gasket combination or a valve plate/gasket combination. The seal can be integrated with a valve or valve plate structure before during or after manufacturing or machining of the valve or valve plate structure, such as by forming a generally uniform seal coating on one or more surfaces of the structure, and/or by forming a raised beaded seal on select portions thereof.

One object of the present invention is to provide a valve or valve plate with an integrated seal to seal against a mating component, thus facilitating elimination of the need for a secondary gasket in a compressor.

Another object of the present invention is to provide a coated valve or valve plate to seal against a mating component thus eliminating the need for a secondary gasket in a compressor.

Yet another object of the present invention is to provide an integral seal to provide an efficient seal in both the suction and discharge sides of a compressor while also reducing assembly time.

Still another object of the present invention is to provide additional control over seal compression, texture, and overall space requirements for a compressor by using a coated valve or valve plate system.

Still another object of the present invention is to give the manufacturer of the valve and valve plate with an integral seal, multiple variations in seal pattern or design, and a reduction in assembly time and/or automated assembly methods.

Still another object of the present invention is that the integrated seal can be concentrated and the material rigidity can be adjusted to provide a proper seal to the mating component all the while having the adhesive properties of the material remain exceptional for bonding to the valve or valve plate.

Still another object of the present invention is the reduction in overall assembly length of the compressor due to the elimination of any secondary gaskets, thus freeing up valuable packaging space in either a refrigerator or automotive vehicle setting.

According to the present invention, the foregoing and other objects and advantages are obtained by a novel design for a valve or valve plate and gasket combination. The integrated valve or valve plate/sealing gasket combination or assembly will include a seal (coating and/or raised bead) on either a valve or valve plate or both to provide an efficient seal on both the suction and discharge sides of a compressor. The integrated seal will allow the elimination of any secondary gasket in the compressor, reduction in assembly time, and additional control over seal compression, texture, and overall space requirements for the compressor unit. The valve or valve plate having an integrated gasket combination may include a plurality of raised beads, alone or in combination with a substantially uniform coating with a sealing material, for additional seal capability depending on the requirements of the compressor.

### BRIEF DESCRIPTION OF THE DRAWINGS

FIG. 1 is a perspective view illustrating a valve assembly having an integrated seal including a coating and a raised beaded seal according to one or more aspects of the present invention;

FIG. 2 is partial sectional perspective view illustrating a cross section of the valve assembly of FIG. 1 according to the present invention; and

FIG. 3 is a perspective view illustrating a valve plate assembly having an integrated seal including a coating and a raised beaded seal according to the present invention.

### DETAILED DESCRIPTION OF THE INVENTION

One or more implementations of the present invention will now be described with reference to the drawings, wherein like reference numerals are used to refer to like elements throughout, and wherein the illustrated structures are not necessarily drawn to scale.

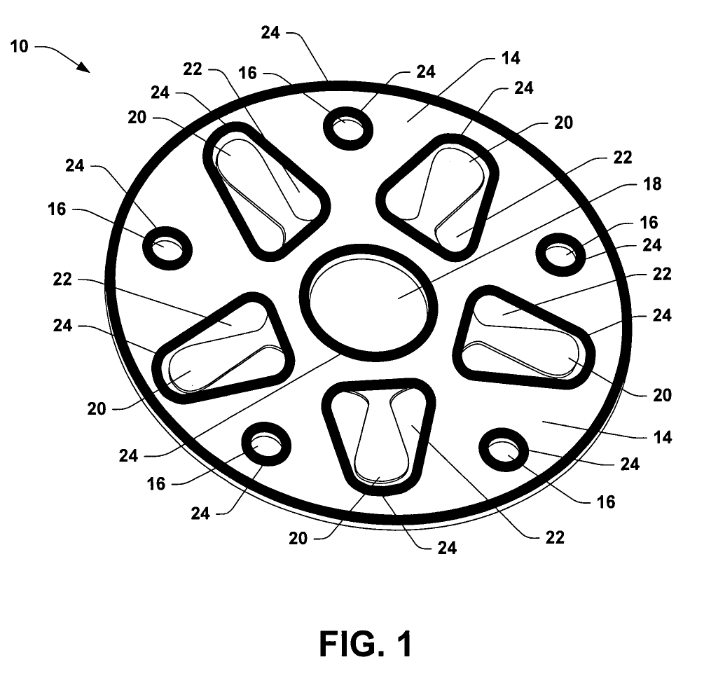

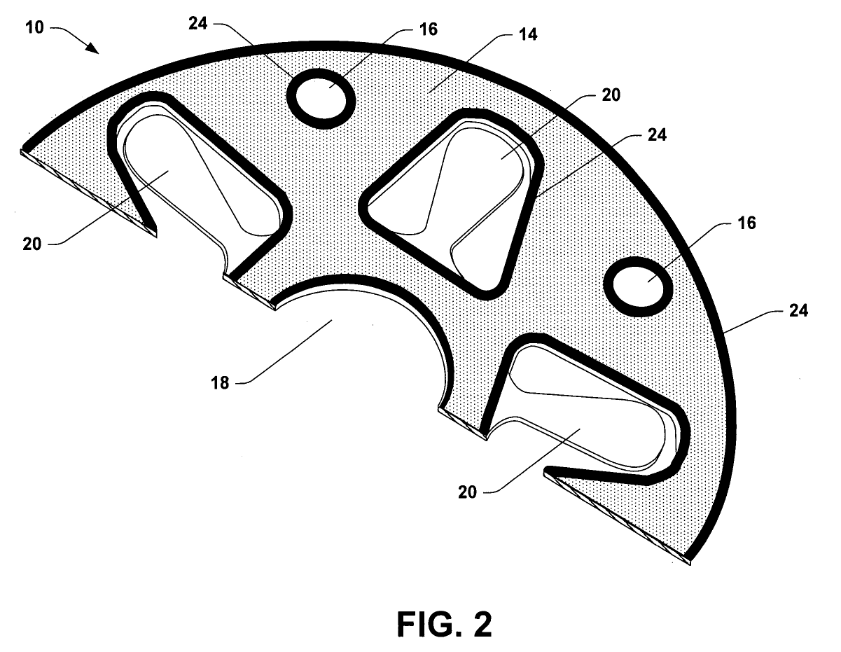

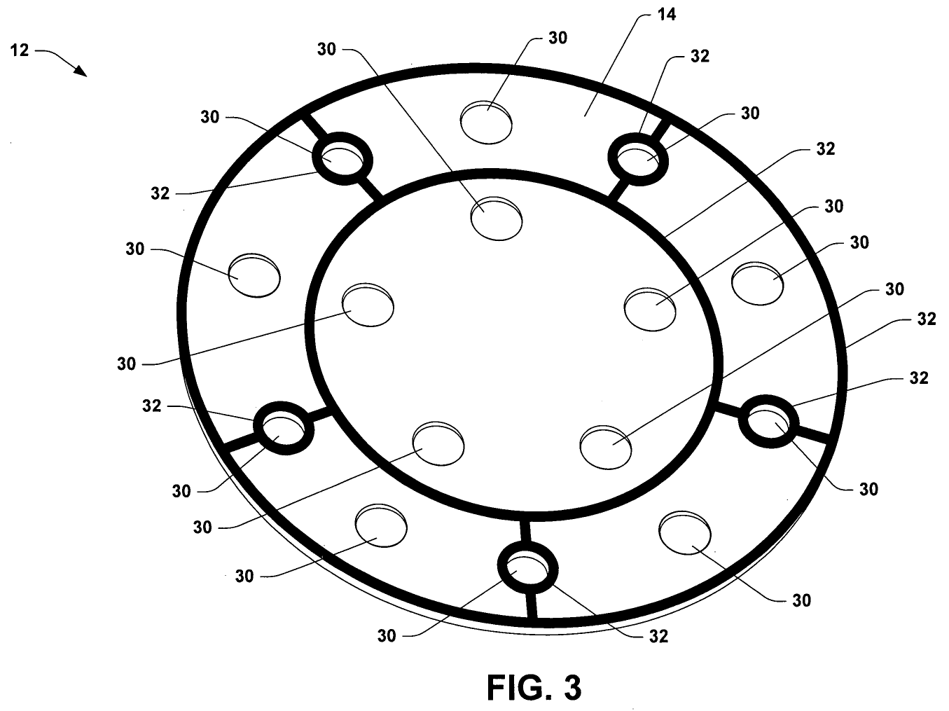

FIGS. 1 and 3 show an integrated valve/gasket combination (e.g., a valve assembly) 10 (hereinafter the valve 10) and an integrated valve plate/gasket combination (e.g., a valve plate assembly) 12 (hereinafter the valve plate 12), respectively, wherein each of the assemblies 10 and 12 comprises an integrated seal according to the present invention. FIGS. 1 and 2 show a valve 10 with an integrated coating or gasket 14 for use in a compressor (not shown). In one embodiment, the compressor may be used in either an automotive or refrigeration environment, in which space is at a premium. However, the various aspects of the present invention may be employed in association with any type of compressor or component environment that uses a valve or valve plate. The use of the coated valve 10 and the integration of the coating seal therein or thereon will facilitate elimination of any secondary gasket and also a reduction in the overall assembly length of the compressor. This will reduce the packaging size for the compressor, thus increasing the desirability of such compressors to the manufacturers of refrigerators, automotive vehicles, or the like.

The valve 10 shown in FIG. 1 generally has a circular disc-like shape, although any other shape may be used for the valve assembly 10 and the valve structure thereof depending on the design requirements of the compressor. The valve structure of the assembly 10 is generally made of a metal material, however any other type of plastic, ceramic, composite, etc. may be used as long as the material is capable of withstanding the environment of the compressor. The valve 10 has a plurality of orifices or apertures 16 therethrough for fastening the valve 10 to the compressor. A circular orifice or aperture 18 is located generally at a center point of the valve 10 and is used to locate the valve 10 with respect to a projection or other component on the inside portion of a valve cover or other compressor component. It should be noted that the orifice 18 may have any known shape. This will align the valve 10 with the orifices through which flow will occur. A plurality of flapper valves or leafs 20 are arranged in an equal distantly spaced radially distributed circumferential pattern. Each of the flapper valves or leafs 20 are arranged within an orifice or opening 22 which surrounds each of the leafs 20. It should be noted that the orifice 22 may be of any size, as long as it is capable of allowing for axial movement of the leaf 20 therein. The flapper valve 20 will operate by moving in an axial direction and sealing the corresponding orifice 22 or allowing flow through the orifice 22 and hence through the compressor. The valve leafs 20 have a pre-determined spring coefficient therein and are capable of flexing in an axial direction to either close off an orifice 22 or allow for flow through the orifice 22 and through the compressor unit.

As shown in FIGS. 1 and 2, the valve 10 according to the present invention comprises a coating 14 over all or substantially all of an entire surface of the valve 10, except for the valve leafs 20. The valve leafs 20 are not coated with the coating or sealing material 14 in the illustrated example, although other embodiments of the present invention are possible in which all or portions of the valve leafs 20 are also coated with the coating or sealing material 14. Moreover, other embodiments are possible, in which only small portions of the overall surface of the valve structure 10 are coated with the sealing material 14. Furthermore, the integrated seal gaskets of the invention may alternatively include only a raised bead seal, or a raised bead seal in combination with the seal coating on all or a portion of the valve structure surface, or a coating with no bead structure. In one embodiment, the coating material 14 is any known polymer material that has sealing capabilities and is compatible with the compressor system environment, although any suitable material 14 may be used within the scope of the present invention. In another contemplated embodiment, a fluoropolymer coating material 14 or the like may be applied to all or a portion of the surface of the valve structure 10. It should be noted that any other type of plastic, rubber, ceramic, fabric, composite, etc. may also be used as the coating material 14 to create the seal for use in the valve 10 (e.g., or in the valve plate assembly 12 of FIG. 3).

According to another aspect of the invention, the valve 10 (e.g., or in the valve plate 12 of FIG. 3) may also include a raised beaded area 24 for additional sealing capabilities within a compressor unit. The raised beaded area 24 generally is in the form of a circular or semicircular hump, although any other shaped hump or raised area may also be used, wherein all such alternative implementations are contemplated within the scope of the present invention. The beaded area 24 generally may facilitate a more concentrated and compressed seal around specific areas of the valve 10. As shown in FIGS. 1 and 2, the raised beaded area 24 generally outlines any of the orifices 16, 18, and/or 22 through the valve assembly 10 as well as the outer periphery of the valve body 10, although this is not a strict requirement of the invention. In this regard, raised beaded areas 24 and/or the coated areas 14 may be located anywhere on a valve 10 or valve plate 12 within the scope of the invention. It is further noted that the coating 14 may be a simple flat seal that is substantially uniform in thickness to provide a generally consistent compression throughout the entire face or surface of the valve 10, thus removing the need for any raised beaded seal areas around specific portions of the valve 10. It should also be noted that the coating 14 and/or the raised beaded areas 24 may be applied to (e.g., integrated with) the structure of the valve 10 prior to manufacturing processes of the valve part 10 (e.g., prior to machining the valve structure) or it may be applied after the valve part 10 has been manufactured (e.g., following machining and polishing), depending on the design requirements and manufacturing capabilities.

It should also be noted that the pattern or design of the seal 14 may vary due to limited sealing surfaces or possible interference with other components during the assembly of the compressor. Therefore, the coating material 14 may be placed at or applied to specific portions or on specific parts, on the entire surface, or in just a beaded manner, or in a combination of all to provide proper sealing capabilities such as these now provided by prior art secondary gaskets. Furthermore, the coating 14 may be applied at varying thicknesses depending on the pressure and environment for the desired compressor application. For instance, where high pressures are found, the thickness of the coating 14 may be increased to ensure a proper seal between the valve 10 and the component it is sealing.

It should be noted that any known chemical, mechanical, or other known bonding process may be used to bond the seal coating 14 to the surface of the valve 10. It should also be noted that the coating 14 may be placed on just one side surface of the valve 10 or on both side surfaces of the valve 10 depending on the design requirements and the compressor being used. It should further be noted that only portions of each side surface of the valve 10 may be coated with the seal material 14 depending on the pressures and environment for the desired compressor application.

FIG. 3 shows a valve plate assembly 12 having an integrated seal coating 14 on a surface thereof. The valve plate assembly 12 and the structure thereof generally have a circular disc-like shape and the plate structure is made of any known metal material, although any hard plastic, ceramic, composite, or the like may be used. It should be noted that the embodiment disclosed shows a circular valve plate 12 but any other shaped valve plate 12 may also be used depending on the application and compressor to be used. The valve plate has a plurality of orifices or apertures 30 therethrough, where some of the orifices 30 are used as means to fasten the compressor valve plate 12 to a compressor unit while others (e.g., port openings 30) may be used as flow paths for the compressor. In the illustrated embodiments, when a valve 10 (e.g., FIGS. 1 and 2 above) is arranged and aligned with a valve plate 12, the leaf or flapper valves 20 of the valve 10 will align with select orifices or ports 30 through the valve plate 12, thus allowing flow of the liquid or gas or other material through the compressor when predetermined pressures are achieved. It should be noted that the orifices 30 generally are shown as circular orifices 30 in FIG. 3, but that any other shape orifice 30 may also be used.

As shown in FIG. 3, a coating 14 is arranged generally on the entire surface of the valve plate assembly 12 in the form of a generally flat seal over the entire surface of the structure 12. The seal coating 14, as described above with respect to the valve 10 of FIGS. 1 and 2, can be employed on the valve plate 12 of FIG. 3, and can be comprised of any known material, such as polymers, having sealing capabilities and which is compatible with the compressor system. It should also be noted that a raised beaded sealing area 32 may also be arranged at specific areas of the valve plate 12 to allow for additional sealing capabilities at such predetermined areas. It should also be noted that a raised beaded sealing area 32 may be the only seal used on the entire valve plate 12 (e.g., without a seal coating 14), or that the flat seal 14 may be the only seal for the entire valve plate assembly 12 (e.g., without the use of the beaded seal 32), or that a combination of the flat seal 14 over a valve plate 12 and a raised beaded area 32 may be used (e.g., as in the embodiment of FIG. 3), depending on the design requirements and compatibilities with the compressor system, wherein all such alternative implementations are contemplated as falling within the scope of the invention and the appended claims.

It should also be noted that the coating 14 which forms the seal 14 may be applied to the valve plate 12 prior to the manufacturing process of the valve plate 12 or applied after the valve plate 12 has been manufactured. As discussed above, the beaded sealing area 32 generally has a circular or semi-circular shape, but may alternatively be any other shape and/or any known height depending on the sealing requirements for the valve plate 12. It should also be noted that the pattern or design of the seal 14 may vary due to limited sealing surfaces or possible interference with other components during the assembly of the compressor unit. Furthermore, the coating of the sealing material 14 may have varying thicknesses depending on the pressures and environment for the specific compressor application.

The use of the coating 14 (e.g., and/or of the raised beaded seals 24, 32) on either the valve assembly 10 (FIGS. 1 and 2) or the valve plate assembly 12 (FIG. 3) or on both, depending on the design requirements, gives an integrated seal concept to the manufacturer or automotive or refrigeration system compressors to allow control of the seal compression, along with multiple variations in the seal pattern and design. Furthermore, the use of the integral coated seal 14 (e.g., and/or of the raised beaded seals 24, 32) facilitates reduced manual assembly time and also reduce time for automated assembly methods. The use of coated integrated seal 14 and/or of the raised beaded seals 24, 32 may provide many advantages over the prior art. For instance, the integrated seal and the application of such coating or beaded seal to the valve 10 or valve plate 12 can be concentrated to specific density requirements and also the rigidity of the sealing material 14, 24, 32 may be adjusted to provide proper sealing to the mating component while the adhesive properties of the material remains high for bonding to the valve 10 or valve plate 12 surface. In the prior art there is shown nowhere any type of integrated seal for use in a compressor on either the suction or discharge sides of a compressor. All of the prior art compressors use secondary gaskets to perform the necessary sealing between valves, valve plates, and their mating components. Furthermore, another advantage of the present invention is that many manufacturers value space in their products, and thus the use of the integrated seal 14, 24, 32 will reduce the overall assembly length of the compressor because of elimination of the secondary gaskets, thus allowing for more packaging space under the hood of an automotive vehicle or within a refrigeration unit depending on the use of the compressor. Furthermore, the use of the seal 14, 24, 32 provides additional control over seal compression, texture, and overall spacing requirements for the valve and valve plate units within a compressor.

While it may be apparent that the preferred embodiments of the invention disclosed are well calculated to fill benefits, objects, or advantages of the invention, it will be appreciated that the invention is susceptible to modifications, variations, and change without departing from the proper scope of the invention as shown. Thus, while the invention has been illustrated and described above with respect to one or more implementations, alterations and/or modifications may be made to the illustrated examples without departing from the spirit and scope of the appended claims. In particular regard to the various functions performed by the above described components or structures (blocks, units, assemblies, devices, circuits, systems, etc.), the terms used to describe such components (including a reference to a “means”) are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising.”

1. A valve or valve plate assembly, comprising:
a valve or valve plate structure; and
a seal integrated with the valve or valve plate structure to provide a seal between the valve or valve plate structure and a mating component in a compressor.

2. The assembly of claim 1, wherein the seal extends along substantially all of a surface of the valve or valve plate structure.

3. The assembly of claim 2, wherein the seal comprises a substantially uniform coating on at least a portion of the surface of the valve or valve plate structure.

4. The assembly of claim 3, wherein the seal further comprises a raised beaded seal formed on a portion of the surface of the valve or valve plate structure.

5. The assembly of claim 4, wherein the raised beaded seal comprises a polymer.

6. The assembly of claim 5, wherein the coating comprises a polymer.

7. The assembly of claim 4, wherein the coating comprises a polymer.

8. The assembly of claim 3, wherein the coating comprises a polymer.

9. The assembly of claim 3, wherein the coating comprises a fluoropolymer material.

10. The assembly of claim 1, wherein the seal comprises a raised beaded seal formed on a portion of a surface of the valve or valve plate structure.

11. The assembly of claim 10, wherein the raised beaded seal comprises a polymer.

12. The assembly of claim 11, wherein the seal further comprises a substantially uniform coating extending on at least a portion of the surface of the valve or valve plate structure.

13. The assembly of claim 12, wherein the coating extends along substantially all of the surface of the valve or valve plate structure.

14. The assembly of claim 12, wherein the coating comprises a polymer.

15. The assembly of claim 12, wherein the coating comprises a fluoropolymer material.

16. The assembly of claim 10, wherein the seal further comprises a substantially uniform coating extending on at least a portion of the surface of the valve or valve plate structure.

17. The assembly of claim 16, wherein the coating comprises a polymer.

18. The assembly of claim 16, wherein the coating comprises a fluoropolymer material.

19. A method of fabricating a valve or valve plate assembly, the method comprising:
manufacturing a valve or valve plate structure; and
integrating a seal with the valve or valve plate structure to form a valve or valve plate assembly.

20. The method of claim 19, wherein integrating the seal with the valve or valve plate structure comprises coating at least a portion of the surface of the valve or valve plate structure with a seal material.

21. The method of claim 20, wherein the seal material comprises a polymer.

22. The method of claim 20, wherein the seal material comprises a fluoropolymer material.

23. The method of claim 20, wherein integrating the seal with the valve or valve plate structure further comprises forming a raised beaded seal on the surface of the valve or valve plate structure.

24. The method of claim 19, wherein integrating the seal with the valve or valve plate structure comprises forming a raised beaded seal formed on at least a portion of the surface of the valve or valve plate structure.

25. The method of claim 24, wherein the raised beaded seal comprises a polymer.

26. The method of claim 19, wherein the seal is integrated with the or valve plate structure after manufacturing the valve or valve plate structure

27. The method of claim 19, wherein the valve or valve plate structure is manufactured after integrating the seal with the valve or valve plate structure.

28. A valve or valve plate assembly, comprising:
a valve or valve plate structure; and
a seal integrated with the valve or valve plate structure.
